(19) United States
(12) Patent Application Publication
(10) Pub. No.: US 2026/0298093 A1
(43) Pub. Date: Oct. 1, 2026

(54) HYBRID ROTOR ARRANGEMENT FOR A GAS TURBINE ENGINE ARCHITECTURE

(71) Applicant: General Electric Company, Evendale, OH (US)

(72) Inventors: Kudum Shinde, Bangalore (IN); Apurv Gupta, Indore (IN); Pradeep Ambiga, Bangalore (IN)

(73) Assignee: General Electric Company, Evendale, OH (US)

(21) Appl. No.: 19/436,326

(22) Filed: Dec. 30, 2025

(30) Foreign Application Priority Data
Mar. 26, 2025 (IN) 202511028447

(51) Int. Cl. F01D 5/02

(52) U.S. Cl. CPC F01D 5/026; F05D 2230/60; F05D 2240/55; F05D 2260/31

(57) ABSTRACT

Structures for hybrid rotor architectures in gas turbine engines, and an assembly method thereof, are described. A gas turbine engine includes a plurality of compressor stages. The gas turbine engine includes a plurality of turbine stages. The gas turbine engine includes a joint between a first compressor stage of the plurality of compressor stages and a first turbine stage of the plurality of turbine stages. The gas turbine engine includes a cone arm coupled to the first compressor stage and the first turbine stage via the joint. The gas turbine engine includes a tie rod threadedly coupled to an end of the cone arm opposite the plurality of compressor stages, the tie rod extending at least a length of the plurality of compressor stages.

### CROSS-REFERENCE TO RELATED APPLICATION

This application claims priority to Indian application 202511028447 filed Mar. 26, 2025, the entire contents of which is hereby incorporated by reference.

### FIELD

The present disclosure relates to gas turbine engines, and more specifically, to features of a hybrid rotor arrangement for a gas turbine engine architecture.

### BACKGROUND

A gas turbine engine for commercial aircraft typically includes a fan and a turbomachine. The turbomachine, which is commonly referred to as the core, generally includes a compressor section, a combustion section, and a turbine section in serial flow arrangement. The compressor section compresses air that is channeled to the combustion section where it is mixed with fuel. The mixture is then ignited for generating hot combustion gases. The combustion gases are channeled to the turbine section which extracts energy from the combustion gases for powering the compressor section, as well as for producing work, such as for propulsion of an aircraft in flight, or for powering a machine such as an electrical generator.

Gas turbine engines have rotors with compressor and turbine disks that are connected axially. The individual disks can be connected through joints or a long tie rod holding the disks. However, there are limitations on weight constraints and overall system operational efficiency.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional view of a gas turbine engine, according to one or more aspects described and illustrated herein;

FIG. 2 schematically depicts a partial view of a hybrid rotor arrangement of the gas turbine engine of FIG. 1, according to one or more aspects described and illustrated herein;

FIG. 3 schematically depicts an enlarged view of a portion of the hybrid rotor arrangement of the gas turbine engine of FIG. 2 as depicted by box 3, according to one or more aspects described and illustrated herein; and

FIG. 4 depicts a flowchart for a method of assembly of the hybrid rotor arrangement of the gas turbine engine of FIG. 2, according to one or more aspects described and illustrated herein.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers only A, only B, only C, or any combination of A, B, and C.

The terms “forward” and “aft” refer to relative positions within a gas turbine engine, pump, or vehicle, and refer to the normal operational attitude of the gas turbine engine, pump, or vehicle. For example, with regard to a gas turbine engine, forward refers to a position closer to an engine inlet and aft refers to a position closer to an engine nozzle or exhaust.

The terms “upstream” and “downstream” refer to the relative direction with respect to a flow in a pathway. For example, with respect to a fluid flow, “upstream” refers to the direction from which the fluid flows, and “downstream” refers to the direction toward which the fluid flows.

As used in this application, stating that any part (e.g., an area) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Approximating language, as used herein throughout the specification and claims, is applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Gas turbine engines have rotors with compressor and turbine disks that are connected axially. The individual disks can be connected through bolted joints or a long tie rod holding the disks. A bolted joint rotor adds weight to the disk, such as bolt weight and bolt hole stress concentration, and also axial space constraints, for example, wrench access purposes.

The tie rod offers benefits, such as providing flexibility to introduce different material combinations which cannot be welded together as well as shorter rotor design. However, the length of the long tie rod spans across both a high pressure compressor and a high pressure turbine, leading to unnecessary increased weight to the engine without providing any modularity when resorting to quick turn operations, such as disassembling the high pressure turbine for troubleshooting or blade replacement purposes. In addition, the tie rod includes numerous challenges, such as meeting criteria of certain operating parameters due to stiffer and larger diameter tie rod that pushes the rotor disk bore outward yielding a heavier rotor design, as well as the capability to withstand blade out dynamic loads with low radius joints in the turbine.

To address the above, a hybrid rotor arrangement including a tie rod and a bolted joint is disclosed, in part, to eliminate regions, such as curved or bent regions, of high stress or load that would otherwise be exhibited for a tie rod rotor structure. In doing so, the overall weight of the engine is reduced, rotor design is shortened, and assembly and disassembly of the engine during high pressure turbine quick turn operations is rapidly enabled without disrupting the high pressure compressor, thereby leading to less maintenance duration and improved fuel burn benefits. As will be further explained, a contoured cone arm along with the hybrid tie rod and bolted joint arrangement is configured to optimize stress distribution, and meet certain operating parameters such as maximum operating speed and vibration margins.

The hybrid rotor arrangement including the tie rod and the bolted joint provides for assembly of the high pressure rotor of a turbofan engine, where the tie rod is in the high pressure compressor, and the bolted joint is in the high pressure turbine. The bolted joint between the high

pressure compressor and the high pressure turbine enables high pressure turbine modularity, independent of the high pressure compressor, during quick turn operations. Moreover, the introduction of the bolted joint in a high pressure turbine forward shaft enables moment carrying capability at a lower radius. As a result of the hybrid rotor arrangement including the tie rod and the bolted joint, an air duct is shortened and is assembled from the aft of the high pressure compressor carrying secondary flow from an end of the tie rod to a high pressure turbine aft.

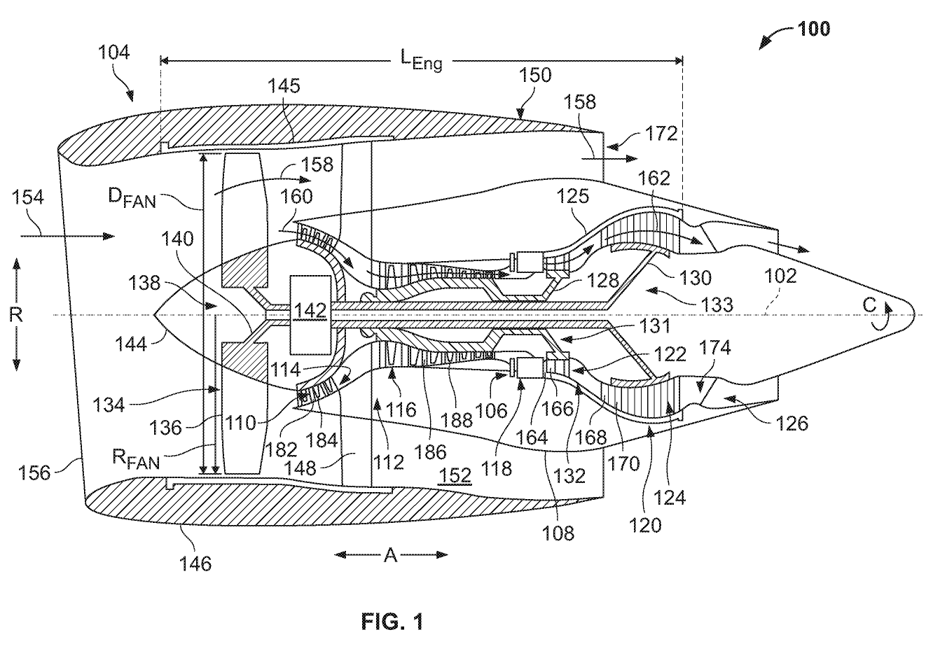

Referring now to the drawings, FIG. 1 provides a schematic cross-sectional view of a turbofan engine 100 according to an example embodiment of the present disclosure. For the depicted embodiment of FIG. 1, the turbofan engine 100 is an aeronautical, high-bypass turbofan engine configured mountable to an aircraft, such as, for example, in an under-wing configuration. As shown, the turbofan engine 100 defines an axial direction A, a radial direction R, and a circumferential direction C. The axial direction A extends parallel to or coaxial with a longitudinal centerline 102 defined by the turbofan engine 100. In certain embodiments, the turbofan engine 100 may include any type of engine, including but not limited to an aviation gas turbine engine, a marine or a power generation gas turbine engine, or any other type of gas turbine.

The turbofan engine 100 includes a fan section 104 and a core turbine engine 106 disposed downstream of the fan section 104. The core turbine engine 106 includes an engine cowl 108 that defines an annular core inlet 110. The engine cowl 108 encases, in a serial flow relationship, a compressor section 112 including a first booster (e.g., a LP compressor 114) and a second booster (e.g., a HP compressor 116), a combustion section 118, a turbine section 120 including a first turbine (e.g., an HP turbine 122) and a second turbine (e.g., an LP turbine 124), and an exhaust section 126. The compressor section 112, the combustion section 118, the turbine section 120, and the exhaust section 126 together define a core air flowpath 132 through the core turbine engine 106.

An HP shaft 128 drivingly connects the HP turbine 122 to the HP compressor 116. An LP shaft 130 drivingly connects the LP turbine 124 to the LP compressor 114. The HP shaft 128, the rotating components of the HP compressor 116 that are mechanically coupled with the HP shaft 128, and the rotating components of the HP turbine 122 that are mechanically coupled with the HP shaft 128 collectively form a high pressure spool, or HP spool 131. The LP shaft 130, the rotating components of the LP compressor 114 that are mechanically coupled with the LP shaft 130, and the rotating components of the LP turbine 124 that are mechanically coupled with the LP shaft 130 collectively form a low pressure spool, or LP spool 133.

The fan section 104 includes a fan assembly 138 having a fan 134 mechanically coupled with a fan rotor 140. The fan 134 has a plurality of fan blades 136 circumferentially-spaced apart from one another. As depicted, the fan blades 136 extend outward from the fan rotor 140 along the radial direction R. A power gearbox 142 mechanically couples the LP spool 133 and the fan rotor 140. The power gearbox 142 may also be called a main gearbox. The power gearbox 142 includes a plurality of gears for stepping down the rotational speed of the LP shaft 130 to provide a more efficient rotational fan speed of the fan 134. In other example embodiments, the fan blades 136 of the fan 134 can be mechanically coupled with a suitable actuation member configured to pitch the fan blades 136 about respective pitch axes, such as, for example, in unison. In some alternative embodiments, the turbofan engine 100 does not include the power gearbox 142. In such alternative embodiments, the fan 134 can be directly mechanically coupled with the LP shaft 130, such as, for example, in a direct drive configuration.

Referring still to FIG. 1, the fan rotor 140 and the hubs of the fan blades 136 are covered by a rotatable spinner 144 aerodynamically contoured to promote an airflow through the plurality of the fan blades 136. Additionally, the fan section 104 includes an annular fan casing 145 and an outer nacelle 146 connected to the fan casing 145. The fan casing 145 and the outer nacelle 146 both circumferentially surround the fan 134 and/or at least a portion of the core turbine engine 106. The fan casing 145 and the outer nacelle 146 are supported relative to the core turbine engine 106 by a plurality of circumferentially-spaced outlet guide vanes 148. A downstream section 150 of the nacelle 146 extends over an outer portion of the core turbine engine 106 so as to define a bypass passage 152 therebetween.

During operation of the turbofan engine 100, a volume of air 154 enters the turbofan engine 100 through an associated inlet 156 of the nacelle 146 and/or the fan section 104. As the volume of air 154 passes across the fan blades 136, a first portion of air 158 is directed or routed into the bypass passage 152 and a second portion of air 160 is directed or routed into the annular core inlet 110. The pressure of the second portion of air 160 is progressively increased as it flows downstream through the LP compressor 114 and HP compressor 116. Particularly, the LP compressor 114 includes sequential stages of LP compressor stator vanes 182 and LP compressor blades 184 that progressively compress the second portion of air 160. The LP compressor blades 184 are mechanically coupled to the LP shaft 130. Similarly, the HP compressor 116 includes sequential stages of HP compressor vanes 186 and HP compressor blades 188 that progressively compress the second portion of air 160 even further. The HP compressor blades 188 are mechanically coupled to the HP shaft 128. Additional details regarding the various components of the LP compressor 114 and the HP compressor 116 will be described in greater detail hereinbelow. The compressed second portion of air 160 is then discharged from the compressor section 112 into the combustion section 118.

The compressed second portion of air 160 discharged from the compressor section 112 mixes with fuel and is burned within a combustor of the combustion section 118 to provide combustion gases 162. The combustion gases 162 are routed from the combustion section 118 along a hot gas path 174 of the core air flowpath 132 through the HP turbine 122 where a portion of thermal and/or kinetic energy from the combustion gases 162 is extracted via sequential stages of the HP turbine stator vanes 164 and the HP turbine blades 166. The HP turbine blades 166 are mechanically coupled to the HP shaft 128. Thus, when the HP turbine blades 166 extract energy from the combustion gases 162, the HP shaft 128 rotates, which supports operation of the HP compressor 116. The combustion gases 162 are routed through the LP turbine 124 where a second portion of thermal and kinetic energy is extracted from the combustion gases 162 via sequential stages of LP turbine stator vanes 168 and LP turbine blades 170. The LP turbine blades 170 are coupled to the LP shaft 130. Thus, when the LP turbine blades 170 extract energy from the combustion gases 162, the LP shaft 130 rotates and supports operation of the LP compressor 114, as well as the fan 134 by way of the power gearbox 142.

The combustion gases 162 exit the LP turbine 124 and are exhausted from the core turbine engine 106 through the exhaust section 126 to provide propulsive thrust. Simultaneously, the pressure of the first portion of air 158 is substantially increased as the first portion of air 158 is routed through the bypass passage 152 before the first portion of air 158 is exhausted from a fan nozzle exhaust section 172 of the turbofan engine 100, also providing propulsive thrust. The HP turbine 122, the LP turbine 124, and the exhaust section 126 at least partially define the hot gas path 174.

It will be appreciated that the turbofan engine 100 depicted in FIG. 1 is provided by way of example, and that in other example embodiments, the turbofan engine 100 has other configurations. Additionally, or alternatively, aspects of the present disclosure may be utilized with other suitable aeronautical turbofan engines, a turboshaft engine, and turboprop engine.

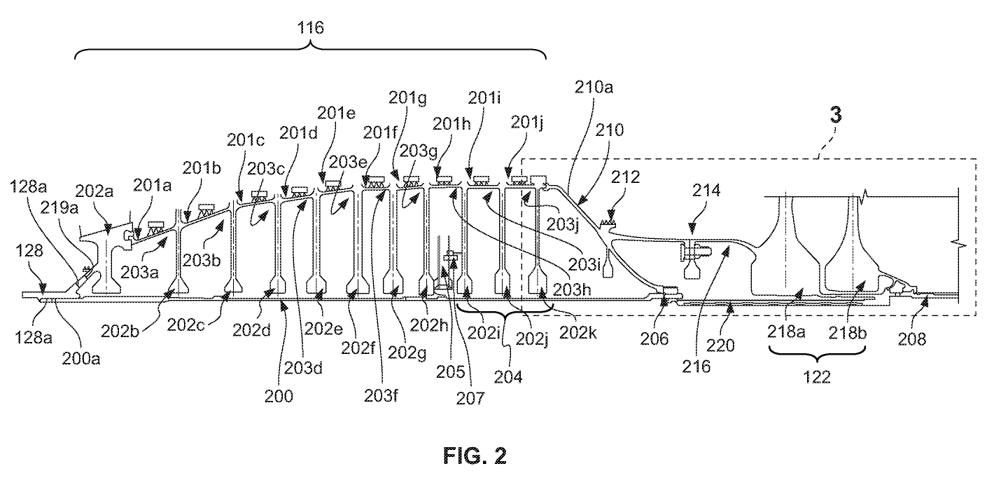

Referring now to FIG. 2, a partial view of a hybrid rotor arrangement of the turbofan engine 100 of FIG. 1 is schematically depicted. The turbofan engine 100 may include a first forward shaft 128, a tie rod 200, a plurality of friction joints 201 (such as a plurality of friction joints 201a-201j), a plurality of compressor stages 202 (such as a plurality of compressor stages 202a-202k), a plurality of spacer arms (such as a plurality of spacer arms 203a-203j), a first coupling nut 206, a second coupling nut 208, a cone arm 210, a seal disk 212, a joint 214, a second forward shaft 216, a plurality of turbine stages 218 (such as a plurality of turbine stages 218a-218b), and an air duct 220. FIG. 2 may reference and incorporate any constituent components of the turbofan engine 100 as explained above with respect to FIG. 1. Although single instances of the constituent components of the turbofan engine 100 of FIG. 2 are depicted, it is understood that any number of constituent components may be included.

The first forward shaft 128 may refer to the HP shaft 128. For example, the first forward shaft 128 may include a high pressure compressor forward shaft that is coupled via one or more male threads 219a and one or more female threads 128a that respectively engage with each other to compressor stage 202a. Moreover, the first forward shaft 128 may be coupled to the tie rod 200. The second forward shaft 216 may include a high pressure turbine forward shaft that is coupled to the turbine stage 218a and the joint 214. In some examples, the second forward shaft 216 may be integrated with the cone arm 210 as a single, monolithic structure. In other examples, the second forward shaft 216 may be a separate structure from the cone arm 210. In certain embodiments, the first forward shaft 128 may include the one or more female threads 128a. The tie rod 200 may include one or more male threads 200a that respectively engage and disengage with the one or more female threads 128a of the first forward shaft 128.

The HP compressor 116 of the turbofan engine 100 may include a plurality of compressor stages 202, which may include axial stages. For example, the plurality of compressor stages 202 may include eleven compressor stages 202a-202k. However, it is understood that the plurality of compressor stages 202 are not limited to such number of compressor stages, and that any number of compressor stages 202 may be used. By way of example, and without limitation, the plurality of compressor stages 202 may include nine compressor stages 202a-202i. In other examples, and without limitation, the plurality of compressor stages 202 may include ten compressor stages 202a-202j.

With continued reference to the plurality of compressor stages 202, any number of the plurality of compressor stages 202 may include a blisk. For example, a first portion of the plurality of compressor stages 202 may include a blisk, and a second portion of the plurality of compressor stages 202 may include a disc. Without limitation, the first portion of the plurality of compressor stages 202 may include five compressor stages 202a-202e, and the second portion of the plurality of compressor stages 202 may include six compressor stages 202f-202k. It is understood that the first portion and the second portion are not limited to these respective numbers, and that any number and/or any combination of blisks and disks of the compressor stages 202 may be used. In certain examples, at least one of the plurality of compressor stages 202 may include a disk with integral/welded blades instead of other forms of blade to disk attachment, such as axial or circumferential dovetail, bolted, or pinned. These are different combinations/types of blade attachments that can be used interchangeably at the at least one of the plurality of compressor stages 202 or any other stage of the compressor.

The tie rod 200 may be configured to extend at least along a length of the plurality of the compressor stages 202, as well as a length of the cone arm 210. By way of example, the tie rod 200 may span across the length of at least the plurality of compressor stages 202a-202k. Each of the spacer arms 203a-203jmay couple a compressor stage 202 to an adjacent compressor stage 202. For example, a spacer arm 203a may couple a compressor stage 202a to a compressor stage 202b. In another example, a spacer arm 203j may couple a compressor stage 202j to a compressor stage 202k.

A spool 204 may include a predetermined number of compressor stages 202. For example, the spool 204 may include three compressor stages 202i-202kthat may be welded together as a single, monolithic structure, as well as respective friction joints 201i-201jand respective spacer arms 203i-203j.

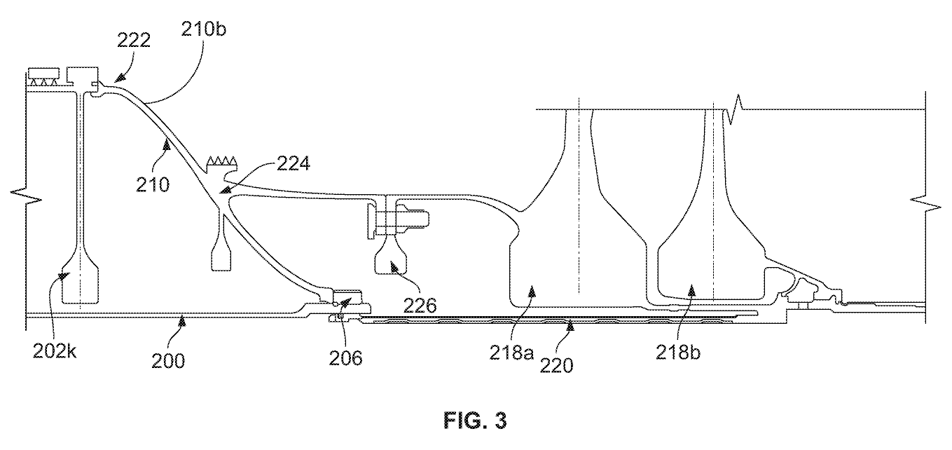

One or more tubes 205 may be attached to at least one of the plurality of the compressor stages 202. By way of example, and without limitation, a first tube 205 may be attached to a bracket 207 of compressor stage 202i. The cone arm 210 may include a straight portion 210a, such as a straight, linear component, that is not curved. In certain embodiment, although the cone arm 210 is depicted to have a curvature portion 210b, it should be appreciated that the cone arm 210 may include the straight portion 210a, such as the straight, linear component, that does not include a curvature. For example, further reference to the cone arm 210 that includes the curved portion 210b will be described with reference to FIG. 3. A seal disk 212 may include a compressor discharge pressure seal disk. For example, the compressor discharge pressure seal disk may secure the cone arm 210 to the joint 214.

The joint 214 may include a bolted joint that is provided between one of the plurality of compressor stages 202 and one of the plurality of turbine stages 218. For example, the joint 214 may be provided between a compressor stage 202k and a turbine stage 218a. The cone arm 210 may be coupled to the compressor stage 202k and the turbine stage 218a via the joint 214. In some examples, the compressor stage 202k may be referred to as an aft end compressor stage. In some examples, the turbine stage 218a may be referred to as a forward end turbine stage.

One or more friction joints 201a-201j may be provided between each of the plurality of compressor stages 202a-202k. For example, a friction joint 201a may couple a spacer arm 203a to a compressor stage 202a. In another example, a friction joint 201f may couple a spacer arm 203f to a compressor stage 202f.

The first coupling nut 206 may be configured to couple the tie rod 200 to the cone arm 210. The second coupling nut 208 may be configured to couple one or more disks of the plurality of the turbine stages 218a-218b to one another. For example, the second coupling nut 208 may be configured to couple the turbine stage 218a directly to the turbine stage 218b. In certain embodiments, after installation of each of the plurality of compressor stages 202, the tie rod 200 may be installed and the plurality of compressor stages 202 may be torqued via the coupling nut 206 as a threaded joint. The high pressure turbine 122, which may include the turbine stage 218a and the turbine stage 218b, is bolted with the plurality of compressor stages 202 at the joint 214.

The air duct 220 may be configured to extend from the tie rod 200 to at least one of the plurality of the turbine stages 218a-218b. For example, the air duct 220 may extend from an end portion of the tie rod 200 and connect to the turbine stage 218a and/or the turbine stage 218b. In certain embodiments, the air duct 220 may be configured to separate air flow coming from a forward side of the HP compressor 116, and air flow coming from aft side of the compressor. Mixing of these airflows is undesirable since there is a need to sufficiently pressurize a bearing housing (not shown). The air duct 220 may be inserted and held using a spline or interference fit with a retainer or a stopper.

FIG. 3 schematically depicts an enlarged view of a portion of the hybrid rotor arrangement of the turbofan engine of FIG. 2. FIG. 3 may reference and incorporate any constituent components of the turbofan engine 100 as explained above with respect to FIG. 1 and FIG. 2. Although single instances of the constituent components of the turbofan engine 100 of FIG. 3 are depicted, it is understood that any number of constituent components may be included. The turbofan engine 100 may include the tie rod 200, the compressor stage 202k, the first coupling nut 206, the cone arm 210, the plurality of turbine stages 218a-218b, the air duct 220, an axial interface 222, a point of inflection 224, and a bore 226. For purposes of brevity, description for constituent components of FIG. 3 that also schematically appear in FIG. 2 will be omitted.

As discussed above, the cone arm 210 may include a curved portion 210b, which may in certain embodiments may be referred to as a contoured portion (as schematically depicted in FIG. 3) to optimize stress distribution, unlike the straight portion 210a of the cone arm 210 schematically depicted in FIG. 2. For example, the cone arm 210 may include a point of inflection 224, which may refer to a point at which the curved portion 210b of the cone arm 210 changes direction.

The axial interface 222 may be configured to reduce load in a radial direction. For example, when a load is applied or added, it may convert to a radial load. Rather than requiring a heavier disk to compensate for handling the load, and to also avoid handling the load at stress points that can break or cause malfunction, the cone arm 210 has a curved portion 210b that transfers the load in an axial direction at the point of inflection 224.

The bore 226 may be configured to secure the joint 214. In some examples, the bore 226 may be referred to as a mini-bore or a compressor disk that supports the joint 214 by holding it in place, as well as prevent the second forward shaft 216 and the cone arm 210 from rotating.

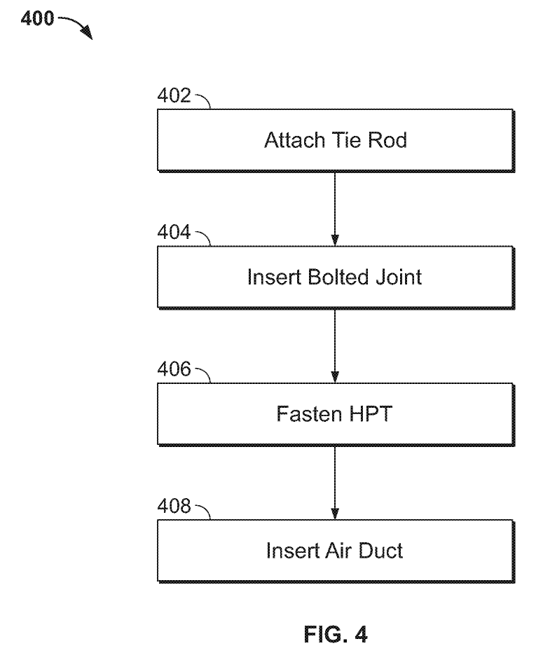

Referring now to FIG. 4, a flowchart for a method 400 of assembly of the hybrid rotor arrangement of the turbofan engine 100 of FIG. 2 is depicted. FIG. 4 may reference and incorporate any constituent components of the turbofan engine 100 as explained above with respect to FIG. 1, FIG. 2, and FIG. 3. Although single instances of the constituent components of the turbofan engine 100 of FIG. 4 are referenced, it is understood that any number of constituent components of the turbofan engine 100 may be referenced.

At block 402, the method 400 may include attaching the tie rod 200. For example, the tie rod 200 may be attached to the turbofan engine 100. In certain embodiments, the tie rod 200 may be attached to the first forward shaft 128 via the one or more male threads 200a that respectively engage and disengage with the one or more female threads 128a of the first forward shaft 128 of the turbofan engine 100.

At block 404, the method 400 may include inserting the bolted joint 214. For example, the bolted joint 214 may be inserted between the plurality of compressor stages 202a-202k and the plurality of turbine stages 218a-218b of the turbofan engine 100. For example, the bolted joint 214 may be inserted between the compressor stage 202k and the turbine stage 218a. In certain embodiments, the high pressure turbine 122, which may include the turbine stage 218a and the turbine stage 218b, may be bolted with the plurality of compressor stages 202 at the joint 214.

At block 406, the method 400 may include fastening the high pressure turbine 122. For example, the plurality of turbine stages 218 that define the high pressure turbine 122 may be fastened by coupling the cone arm 210 to the first compressor stage 202k of the plurality of compressor stages 202 and the first turbine stage 218a of the plurality of turbine stages 218 via the bolted joint 214. As previously explained above, the cone arm 210 may include the straight portion 210a, such as a straight, linear component, or the curvature portion 210b. Further, an end of the cone arm 210 that is opposite the plurality of compressor stages 202 may be threadedly coupled to the tie rod 200. In certain embodiments, each of the plurality of compressor stages 202 may be installed, after which the tie rod 200 is installed and the plurality of compressor stages 202 may be torqued via the coupling nut 206 as the threaded joint.

In particular, the first coupling nut 206 may be inserted to couple the tie rod 200 to the cone arm 210. The second coupling nut 208 may be inserted to couple one or more disks of the plurality of the turbine stages 218a-218b. For example, the second coupling nut 208 may be inserted to couple one or more disks of the turbine stage 218a and/or one or more disks of the turbine stage 218b.

At block 408, the method 400 may include inserting an air duct 220. For example, the air duct 220 may be inserted into the turbofan engine 100 and, in particular, inserted to extend from the tie rod 200 to at least one of the plurality of the turbine stages 218a-218b. For example, the air duct 220 may extend from an end portion of the tie rod 200 and connect to the turbine stage 218a and/or the turbine stage 218b. In certain embodiments, the air duct 220 may be configured to separate air flow coming from a forward side of the HP compressor 116, and air flow coming from aft side of the compressor. Mixing of these airflows is undesirable since there is a need to sufficiently pressurize a bearing housing.

Without departing from the scope of the disclosure, the reverse sequence of method steps of method 400 may be carried out for a method of disassembly of the hybrid rotor arrangement of the turbofan engine 100. In particular, the method of disassembly of the hybrid rotor arrangement of the turbofan engine 100 may include beginning with an opposite operation of block 408, an opposite operation of block 406, an opposite operation of block 404, and an opposite operation of block 402.

For example, the method of disassembly of the hybrid rotor arrangement of the turbofan engine 100 may include removing the air duct 220. The air duct 220 may be removed so as to not extend from the tie rod 200 and disconnect from the turbine stage 218a and/or the turbine stage 218b. In certain embodiments, the air duct 220 may be removed from being held using the spline or interference fit with the retainer or the stopper.

The method of disassembly of the hybrid rotor arrangement of the turbofan engine 100 may include unfastening the high pressure turbine 122. For example, the first coupling nut 206 may be removed to decouple the tie rod 200 from the cone arm 210. In certain embodiments, the high pressure turbine 122, including the turbine stage 218a and the turbine stage 218b, may be debolted from the plurality of compressor stages 202 at the joint 214. The second coupling nut 208 may be removed to decouple the one or more disks of the plurality of the turbine stages 218a-218b. The plurality of turbine stages 218 may be unfastened by decoupling the cone arm 210 from the first compressor stage 202k and the first turbine stage 218a via the bolted joint 214.

The method of disassembly of the hybrid rotor arrangement of the turbofan engine 100 may include removing the bolted joint 214. For example, the bolted joint 214 may be removed between the compressor stage 202k and the turbine stage 218a.

The method of disassembly of the turbofan engine 100 may include detaching the tie rod 200. For example, the one or more male threads 200a of the tie rod 200 may be disengaged with the one or more female threads 128a of the first forward shaft 128 of the turbofan engine 100.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A turbofan engine, comprising: a plurality of compressor stages; a plurality of turbine stages; a joint between a first compressor stage of the plurality of compressor stages and a first turbine stage of the plurality of turbine stages; a cone arm coupled to the first compressor stage and the first turbine stage via the joint; and a tie rod threadedly coupled to an end of the cone arm opposite the plurality of compressor stages, the tie rod extending at least a length of the plurality of compressor stages.

The turbofan engine according to the previous clause, further comprising a first forward shaft coupled to one of the plurality of compressor stages, and a second forward shaft coupled to the first turbine stage and the joint.

The turbofan engine according to any preceding clause, further comprising a seal disk between the cone arm and the joint.

The turbofan engine according to any preceding clause, further comprising a first coupling nut that is configured to couple the tie rod to the cone arm.

The turbofan engine according to the previous clause, further comprising a second coupling nut that is configured to couple one or more discs of the plurality of the turbine stages.

The turbofan engine according to any preceding clause, further comprising an air duct that extends from the tie rod to connect to at least one of the plurality of the turbine stages.

The turbofan engine according to any preceding clause, further comprising one or more friction joints between each of the plurality of the compressor stages.

The turbofan engine according to any preceding clause, wherein the cone arm includes a curved portion.

The turbofan engine according to any preceding clause, wherein the cone arm includes a straight portion.

The turbofan engine according to any preceding clause, wherein the cone arm includes a point of inflection, the point of inflection including a point at which a portion of the cone arm changes direction.

The turbofan engine according to any preceding clause, further comprising a bore configured to secure the joint.

The turbofan engine according to any preceding clause, further comprising an axial interface configured to reduce load in a radial direction.

The turbofan engine according to any preceding clause, further comprising a first forward shaft that includes one or more female threads, wherein the tie rod comprises one or more male threads that respectively engage with the one or more female threads.

The turbofan engine according to any preceding clause, wherein the tie rod extends at least along a length of the plurality of the compressor stages and a length of the cone arm.

The turbofan engine according to any preceding clause, further comprising one or more tubes attached to a bracket of at least one of the plurality of the compressor stages.

A method comprising: attaching a tie rod to a turbofan engine; inserting a joint between a plurality of compressor stages and a plurality of turbine stages of the turbofan engine; fastening the plurality of turbine stages by coupling a cone arm to a first compressor stage of the plurality of compressor stages and a first turbine stage of the plurality of turbine stages via the joint; and inserting an air duct that extends from the tie rod to connect to at least one of the plurality of the turbine stages.

The method according to the preceding clause, further comprising threadedly coupling the tie rod to an end of the cone arm opposite the plurality of compressor stages, the tie rod extending at least a length of the plurality of compressor stages.

The method according to any preceding clause, coupling a first forward shaft to one of the plurality of compressor stages; and coupling a second forward shaft to the first turbine stage and the joint.

The method according to any preceding clause, further comprising coupling the tie rod to the cone arm via a first coupling nut; and coupling one or more discs of the plurality of turbine stages via a second coupling nut.

The method according to any preceding clause, further comprising securing the joint via a bore.

We claim:

1. A turbofan engine, comprising:
a plurality of compressor stages;
a plurality of turbine stages;
a joint between a first compressor stage of the plurality of compressor stages and a first turbine stage of the plurality of turbine stages;
a cone arm coupled to the first compressor stage and the first turbine stage via the joint; and
a tie rod threadedly coupled to an end of the cone arm opposite the plurality of compressor stages, the tie rod extending at least a length of the plurality of compressor stages.

2. The turbofan engine of claim 1, further comprising a first forward shaft coupled to one of the plurality of compressor stages, and a second forward shaft coupled to the first turbine stage and the joint.

3. The turbofan engine of claim 1, further comprising a seal disk between the cone arm and the joint.

4. The turbofan engine of claim 1, further comprising a first coupling nut that is configured to couple the tie rod to the cone arm.

5. The turbofan engine of claim 4, further comprising a second coupling nut that is configured to couple one or more discs of the plurality of the turbine stages.

6. The turbofan engine of claim 1, further comprising an air duct that extends from the tie rod to connect to at least one of the plurality of the turbine stages.

7. The turbofan engine of claim 1, further comprising one or more friction joints between each of the plurality of the compressor stages.

8. The turbofan engine of claim 1, wherein the cone arm includes a curved portion.

9. The turbofan engine of claim 1, wherein the cone arm includes a straight portion.

10. The turbofan engine of claim 1, wherein the cone arm includes a point of inflection, the point of inflection including a point at which a portion of the cone arm changes direction.

11. The turbofan engine of claim 1, further comprising a bore configured to secure the joint.

12. The turbofan engine of claim 1, further comprising an axial interface configured to reduce load in a radial direction.

13. The turbofan engine of claim 1, further comprising a first forward shaft that includes one or more female threads, wherein the tie rod comprises one or more male threads that respectively engage with the one or more female threads.

14. The turbofan engine of claim 1, wherein the tie rod extends at least along a length of the plurality of the compressor stages and a length of the cone arm.

15. The turbofan engine of claim 1, further comprising one or more tubes attached to a bracket of at least one of the plurality of the compressor stages.

16. A method, comprising:
attaching a tie rod to a turbofan engine;
inserting a joint between a plurality of compressor stages and a plurality of turbine stages of the turbofan engine;
fastening the plurality of turbine stages by coupling a cone arm to a first compressor stage of the plurality of compressor stages and a first turbine stage of the plurality of turbine stages via the joint; and
inserting an air duct that extends from the tie rod to connect to at least one of the plurality of the turbine stages.

17. The method of claim 16, further comprising threadedly coupling the tie rod to an end of the cone arm opposite the plurality of compressor stages, the tie rod extending at least a length of the plurality of compressor stages.

18. The method of claim 16, further comprising:
coupling a first forward shaft to one of the plurality of compressor stages; and
coupling a second forward shaft to the first turbine stage and the joint.

19. The method of claim 16, further comprising:
coupling the tie rod to the cone arm via a first coupling nut; and
coupling one or more discs of the plurality of turbine stages via a second coupling nut.

20. The method of claim 16, further comprising securing the joint via a bore.
